(19) United States
(12) Patent Application Publication
(10) Pub. No.: US 2009/0055433 A1
(43) Pub. Date: Feb. 26, 2009

(54) System, Apparatus and Method for Organizing Forecasting Event Data

(75) Inventor: Ilana Freedman, Billerica, MA (US)

Correspondence Address: MCDERMOTT WILL & EMERY LLP, 28 STATE STREET, BOSTON, MA, 02109-1775, US

(73) Assignee: Gerard Group International LLC, Tyngsborough, MA (US)

(21) Appl. No.: 12/180,014

(22) Filed: Jul. 25, 2008

Related U.S. Application Data
(60) Provisional application No. 60/961,888, filed on Jul. 25, 2007.

(51) Int. Cl. G06F 17/30

(52) U.S. Cl. 707/103 R; 707/E17.045

(57) ABSTRACT

The invention relates to a system and method for improving the accuracy of forecasting by analyzing information in advance of some forecast window. In one embodiment, the method includes the steps of: for each of a plurality of users acquiring a plurality of data; tagging each datum with information about the datum; creating weighted bi-directional relational links between data; aggregating and integrating the tagged data and weighted bi-directional links and collaboratively analyzing paths through the weighted bi-directional relational links to predict an event. In one embodiment, the system includes a data acquisition module for acquiring a plurality of data; a data tagger for tagging each datum with information about the datum; a network generator for creating weighted bi-directional relational links between datum; an aggregator to aggregate the tagged data and weighted bi-directional links, an integrator to integrate the data and link related data, and a collaborative analyzer for analyzing paths through the weighted bi-directional links to predict an event.

### RELATED APPLICATION

The present application is based upon and claims priority from U.S. Provisional Application No. 60/961,888 filed Jul. 25, 2007.

### TECHNICAL FIELD

The invention relates to an apparatus, system and method that facilitate the analysis of data for the purposes of informing decision making. In one embodiment, the invention relates to an automated system for collecting, filtering, and organizing data to forecast outcomes in response thereto.

### BACKGROUND

Decisions are as only as good as the analysis that informs them. In turn, well reasoned analysis often turns on many underlying facts and assumptions that are developed after much painstaking research. In the intelligence community, the advertising community, and the scientific community, large amounts of data are often available that could be used to draw rational conclusions and forecast possible outcomes. However, given that the amount of superfluous data far exceeds the amount of relevant facts, it is difficult to organize data and develop new leads. These issues are further complicated by the fact that the relevancy of data changes over time. In addition, as the patterns and connections that illuminate the relevancy of particular data are often only noticeable in hindsight, it is difficult to identify what data warrants attention and what data can be ignored.

Accordingly, a need exists for data analysis techniques, devices, and systems that facilitate automated data analysis that, in part, mimics human intuition to identify quality data, improves the signal to noise ratio when searching for initial leads, and enables real time analysis such that changing facts are reflected in the decision making process.

### SUMMARY OF THE INVENTION

In one aspect, the invention relates to techniques for improving the accuracy associated with forecasting by properly analyzing enough available information in advance of some forecast window. As part of the analytic approaches described herein, data is collected over time to inform research and make predications. Incoming data is weighted and tagged for linkage with other data according to various parameters. All accumulated data is retained. Data is retained because as new leads and patterns emerge, cross-checking data points with previously ignored data can identify new patterns and sources for forecasting and decision making. Further, acquiring additional data can lead to more accurate outcomes in some embodiments. The processes of researching, performing analysis and drawing conclusions occur in parallel. Also, there is continuous interaction between these processes. Also, multiple streams of data are processed simultaneously and the multiple streams are continually crossed referenced to establish relationships between diverse data. As data is collected and used, all of the information that forms the basis for analysis and conclusions is validated through a variety of criteria. The analytical techniques employed in various embodiments of the invention can be both intuitive and empirical. The weighted links and tagged data from the individual specialists are then aggregated and the aggregated data collaboratively analyzed.

In another aspect, the invention relates to a method of organizing forecasting event data. In one embodiment, the method includes the steps of acquiring a plurality of data; tagging each datum with information about the datum; creating weighted bi-directional relational links between data; and analyzing paths through the weighted bi-directional relational links to predict the likelihood of an event. In one embodiment, the information about each datum includes source; keywords; context; date and time; probability of validity; and weight. In another embodiment, the information about each datum includes an indication of importance. In yet another embodiment, the indication of importance is determined automatically. In still yet another embodiment, the method further includes the step of displaying paths through the weighted bi-directional relational links.

In another embodiment, data is acquired from multiple sources. In another embodiment, the steps of acquiring the plurality of data include the step of acquiring data in multiple formats and converting the data into a common format. In yet another embodiment, the probability of validity of a datum is modified in response to other data.

Another aspect of the invention is a system for organizing data for forecasting events. In one embodiment, the system includes a data acquisition module for acquiring a plurality of data; a data tagger for tagging each datum with information about the datum; a network generator for creating weighted bi-directional relational links between datum; and an analyzer for analyzing paths through the weighted bi-directional relational links to predict the likelihood of an event. In another embodiment, the information about each datum includes source; keywords; context; date and time; probability of validity; and weight. In yet another embodiment, the information about each datum includes an indication of importance. In still yet another embodiment, the system includes an importance determination module for automatically determining an indication of importance.

In another embodiment, the system includes a display for displaying paths through the weighted bi-directional relational links.

In another embodiment, the system further includes a storage device for storing data from multiple sources. In yet another embodiment, the data acquisition module acquires the plurality of data in multiple formats and converts the data into a single format. In still yet another embodiment, the system includes a probability modification module for modifying the probability of validity of a datum in response to other data.

It should be understood that the terms “a,” “an,” and “the” mean “one or more,” unless expressly specified otherwise.

As used herein “communication with” refers to direct or indirect communication.

The foregoing, and other features and advantages of the invention, as well as the invention itself, will be more fully understood from the description, drawings, and claims which follow.

### BRIEF DESCRIPTION OF THE DRAWINGS

Reference to the FIGURE herein is intended to provide a better understanding of the methods and apparatus of the invention but is not intended to limit the scope of the invention to the specifically depicted embodiments. The drawings are not necessarily to scale, emphasis instead being placed upon illustrating the principles of the invention. Like reference characters in the respective figures typically indicate corresponding parts.

FIG. 1 is a block diagram of an embodiment of a system constructed in accordance with the invention.

### DETAILED DESCRIPTION

The following description refers to the accompanying drawings that illustrate certain embodiments of the present invention. Other embodiments are possible and modifications may be made to the embodiments without departing from the spirit and scope of the invention. Therefore, the following detailed description is not meant to limit the present invention. Rather, the scope of the present invention is defined by the appended claims.

It should be understood that the order of the steps of the methods of the invention is immaterial so long as the invention remains operable. Moreover, two or more steps may be conducted simultaneously unless otherwise specified.

In general, aspects of the invention relate to data analysis tools that attempt to simulate the intuition of an individual or team of analysts to process large volumes of data and provide accurate forecasts. Instead of imposing a particular scenario or hypothesis on the data, some of the approaches described herein work from a data centric approach that is independent of any preconceptions. As a result, the forecasts and predictions that may arise from a given data analysis session may detect patterns and enable the formulation of response strategies that would otherwise be impossible if a set of assumptions were simply being fit to a plurality of data sets. Analysis performed to date has revealed that proper data scoring and organization is correlated with prediction accuracy.

The widely-used method of forecasting now used by many groups engaged in supporting decision making and mission objectives employs a scenario-based methodology, created on the basis of a limited set of data, that is then either proved or disproved. This methodology frequently fails because it depends on trial and error to reach a favored scenario and uses only a small portion of the vast wealth of information available. Also, many of these approaches lack proper data processing and organization.

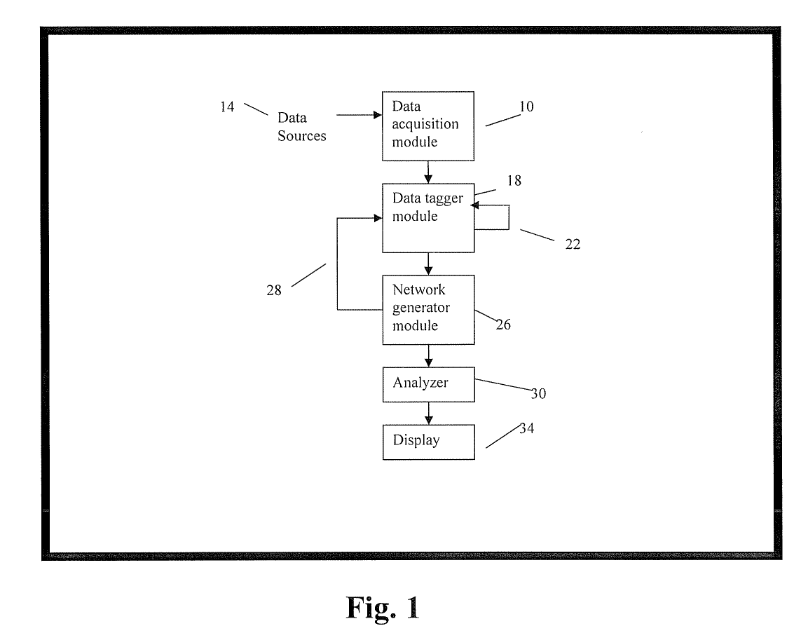

In brief overview and referring to FIG. 1, a computer system constructed in accordance with the invention includes a data acquisition module 10 that takes in data from a plurality of sources 14. Each datum of the data is tagged by a data tagger module 18 with information about the datum. In various embodiments, the information about the datum includes the source of the information, keywords associated with the datum, the context in which the datum is used, the date and time at which the datum was acquired by the source, the probability that the datum is accurate and the relative weight of the datum. In other embodiments, the datum is tagged with a measure of importance.

Thus, by way of example, a datum of the number of warships in the South China Sea which belong to non-friendly states may have the following information associated with it. The source is the US National Security Agency satellite imaging group. The data was collected on Jun. 5, 2005. The probability that the data is valid is high and the weight of the datum is three on a scale of one to ten, because at this time there are no hostilities with any of the states involved. Finally, the measure of importance is eight on a scale of one to ten because history has shown that when there is an accumulation of sea power between non-friendly nations in a single region, the probability of a hostile engagement increases.

The information tags placed on the data by the tagger module 18 may be modified 22 by other subsequent data in the data tagger module 18. Thus, in the example given, a subsequent datum of the large number of soldiers poised on disputed border by the same non-friendly nations which also have ships in the South China Sea may cause the weight of the warship datum to rise because although there is no hostility at the time the data was collected, the probability of hostility may be increasing. Further, the importance of the datum may also rise because the increased probability of hostility may require intervention by the US Navy in the South China Sea.

As the data is tagged, a network generation module 26 links each datum to other data to form a network. Again, the existence of links between data may cause the information tagged to the data to change 28. In the example given, additional data such as a speech by the leader of one of the non-friendly nations whose soldiers are on the disputed border stating that the leader's country will use force if necessary to keep its sea lanes open may again cause the weight or the importance of the warship data to change.

As the network is created, the links between the nodes (data) of the network are weighted to indicate how tightly coupled are the data. Thus, in the example given the number of warships may be very tightly coupled to the data with the types of warships and less tightly coupled to the number of planes in the respective country's air force.

An analyzer 30 then traces the various network connections to predict the outcome of the present set of data correlated with a particular data pattern. So for example, a trace from a datum indicating how many skirmishes have occurred on the disputed border through the number of ships in the South China Sea may indicate that the probability is high that some hostile activity will occur in the South China Sea as a result of a border skirmish. The results from the analyzer 30 may then be displayed in various formats on a display 34.

It will be apparent to one of ordinary skill in the art that the embodiment just described may be implemented in software, firmware, and hardware. The actual software code or specialized control hardware used to implement some of the present embodiments does not limit the scope of the invention. Moreover, the processes associated with some of the present embodiments may be executed by programmable equipment, such as a general purpose computer. Software that may cause programmable equipment to execute the processes may be stored in any storage device, such as, for example, a computer system (non-volatile) memory, an optical disk, a magnetic tape, or a magnetic disk. The modules herein may be implemented in various languages such as, for example, C++. In addition, software embodiments may be added or updated to support additional device platforms.

In more detail and referring again to FIG. 1, some of the methodologies described herein are based on a theory of historical analysis which assumes that by following the threads leading up to a single historical event, one can understand its inevitability. The theory, which works within the historical context by looking backward, can be similarly applied to the future for forecasting future trends by analyzing current realities and the associated threads of data and information and looking forward. By taking the information ‘on the ground,’ it is possible to analyze it in order to accurately identify the most probable trends and a single future event in the near to mid-term future (1-5 years). While the first assumption requires only a few trend lines to prove the theory backwards, the second requires a great deal more input of information to enable the analyst to extrapolate the data into future trend-lines. In fact, the more data applied to the analysis, the more accurate the forecast.

In today's complex global theater, with vast sources of information and ever-increasing numbers of threats, the ability to quickly analyze the massive quantities of data accurately is essential to formulating timely and useful forecasts. The methodology described here can provide a total solution to the existing quandary with which intelligence services and other data-intensive industries continue to struggle.

As discussed above, a need exists for a reliable analytical methodology suitable for organizing data and forecasting events of interest to an analyst performing research with respect to a particular field. In the intelligence community, and in other fields of research, data analysis is commonly performed by agent analysts working independently from each other. This often results in insufficient sharing of either raw data or the analytical output arising from the processed data. This well-documented phenomenon is also manifest in the boundaries erected between departments and agencies. Unfortunately, this insular approach hampers the more thorough understanding that can be accomplished via shared knowledge and dynamic collaborative analysis.

In part, the methodology described herein facilitates the analysis of large amounts of qualitative data. This analysis can be performed quickly and accurately. Combining the benefits of pooled knowledge and dynamic, cooperative analysis, the analysis is supported by a system that weighs and links data according to a complex set of rules, and enables the utilization of all acquired data. No information is ever discarded and all processes are carried on in parallel, keeping the output timely and relevant. The process is dynamic and reporting can be carried out at any stage of the process. The output is actionable intelligence that is fully supported and visually demonstrable. The output is supported in the sense that the underlying analysis and decisions can be traced back in time serially, such that assumptions can be evaluated after action has been taken or new data comes to light. Because the time series of the data intrinsically includes geographic information, this spatial aspect is augmented with a temporal aspect leading to a multi-dimensional database in space and time.

Some of the aspects of the invention disclosed herein are based on the assumption that large amounts of data, properly tagged and linked, can provide a dynamic and accurate picture of highly complex environments. The methodology can be efficient and accurate in environments ranging from the commercial space to the counter-terrorism space.

Looking at each step of the process individually, data is acquired from a broad range of sources including news, authored articles and analyses, general and trade publications, the Internet, interviews, e-mails and chat rooms, etc. Most of the input is the form of qualitative information. The data acquisition module, which in one embodiment is configured as a search engine obtaining information from multiple types of sources (Internet, chat, e-mail, proprietary), automatically takes and stores information from multiple sources and online databases, converts multiple formats, and handles a plurality of languages and character sets. In addition to the search engine being able to accept text files, the engine will accept video, image and audio files. A benefit of such a search engine using search agents that can focus on the desired information is that the engine can search multiple databases and websites 24 hours a day, seven days a week.

In addition to the search engine, the data acquisition module allows for manual input of information, including human gathered intelligence (HUMINT), and will convert scanned documents to text and images. Because the data acquisition module allows data to be added and errors corrected, the module provides a secure audit trail for all information, including manually loaded information.

In one embodiment, this database is proprietary and access to it is provided on a pay-per-use basis. Such a database is secure in order to prevent unauthorized access and protect client information. This is accomplished through a combination of encryption and advanced anti-hacking and virus protection features. The data itself is partitioned with various levels of security requiring authorization in order to protect the data and prevent unauthorized access. No data is ever discarded because what seems irrelevant today may be critical tomorrow and the more data acquired, the more accurate the analysis.

As the large amounts of qualitative information are acquired, the incoming data, which takes the form of articles, analyses, interviews, e-mail, chatter, reports, briefings, etc., is weighted (tagged) and linked to other relevant data, and stored in a dynamically expandable database. It is during this procedure that the information is analyzed and measured against various rules for validity, accuracy, and relevance.

The data tagger module tags information with a date and time stamp; an identification of source and a probability of validity, which may be calculated or assigned by an operator or is learned by the module using a learning module over time. If no source is designated, “no-source” is listed in the tag indicating that the reliability of the information is unknown. The data is assigned keywords, the context of the information, and an appraisal of its importance. The data is then compared and contrasted with other information.

In one embodiment, each intelligence datum about a given subject or object is associated with the following variables:

Importance: the value and potential impact this data point may connote

Action Factor: whether some action taking place or being planned and whether the datum is an action by one or many

Source: how this datum was obtained

Source Factor: how reliable is the source

Source Location: the location of the source of the datum

Relevance: what links between this datum and other data exist and what is the strength of the link

Time/Timing: the date and time the reported datum occurred and the date and time the datum was first reported

Simultaneous Events: at the time the datum occurred, what events of interest occurring simultaneously in proximity to the datum event

Physical Location: the location of the event

Possibility of Coding: the probability that the information is coded as determined by its appearance (odd and out of character) and whether the information clashes

Relationship Factor: the existence of a familial, tribal or friendship relationship between the object of the datum and the object of other data

Validity of the Datum: taken as a whole, the probability that the datum is valid

In addition other variables may be associated with the datum depending upon the character of the object of the datum. For example these additional variables may include:

Aliases: of human or organizational subjects

Variations of Spelling: variations in the spelling and translation of names which sound similar or have similar spellings that help determine whether the names should or should not be connected

Dialect Variables: whether variations in the spelling of a word in one dialect, results in a significantly different meaning in a different but similar dialect

Translation Variables: the accuracy of the translator

Each one of the variables may itself be determined by other variables. For example, in one embodiment, the following metrics are used to determine the validity of the information: source; reliability of the source; corroborating information; expert opinion of the value of the information; unanimity of expert opinion; and use of the source by the experts. If the information is corroborated, then the frequency of the information; number of sources originating the information; and the amount of analysis the information has been subjected to is considered.

Each of these variables may be given a score from 0 to 100 quantifying the value of the variable. For example, if the source of the datum is very reliable, the source may be scored as 90. If there is no chance that the datum relates to some form of code, the possibility-of-coding variable is set to 0.

Next, the information is examined to determine if the information as a whole is relevant to the subject of the research that caused the information to be gathered, and if not, are any portions of the information relevant. Further, the information is examined to determine if parts of the information are relevant to each other or relevant to information that was considered irrelevant previously. The information is then checked for accuracy and whether it makes sense in the context of other information considered to be accurate. Finally, whether the new information clusters with previously accepted information; whether the clusters are compact; and the location of the clusters in the variable space are considered.

All the information is cross-referenced and bi-directionally linked, by the network generation module, to other information, with the links themselves being given weights. In one embodiment, the weights on a scale of 1-100 indicate the following:

| | |
|---|---|
| Negligible correlation | 0 to 10 |
| Slight correlation | 10 to 20 |
| Low correlation | 20 to 30 |
| Intermediate correlation | 30 to 40 |
| Mean correlation | 50 to 60 |
| Elevated correlation | 60 to 70 |
| High correlation | 70 to 80 |
| Crucial correlation | 80 to 90 |
| Near Certain correlation | 90 to 100 |

The links themselves are not static and may change with time. Because most of the acquired data is qualitative in nature, the generation of links and relationships among high volume and diverse qualitative data is significant. The theory of six degrees of separation applies to intelligence. No piece of intelligence is more than six links away from any other piece of intelligence.

To understand how the links change with time, consider the following example. Components of explosives are missing from a location and the thief and purpose of the theft is unknown. No additional information relating to the theft is determined for years. At about the same time, a young child (Person A) visited a neighbor's (Person B) child when another guest (Person C) was present. The persons involved had no other known link or connection other than this datum and the existence of this visitation was only noted because Person C was being watched as a potential terrorist. The scoring weights on the child (Person A) are therefore assigned to a low level for lack of relevance, timing, and other variables. However, this datum is not discarded, but rather, is saved for future reference. The weighted scores for this scenario at time (t1) would be:

| Weighted | Person | Person | Person |
|---|---|---|---|
| Scores | A to B | A to C | B to C |
| Importance | 5 | 12 | 54 |
| Action Factor | 5 | 0 | 0 |
| Reliability | 84 | 84 | 84 |
| Relevance | 2 | 2 | 49 |
| Timing/Time | 2 | 2 | 56 |
| Physical | 5 | 20 | 20 |
| Location | | | |
| Coding | 0 | 0 | 0 |
| Raw Score: | 103 | 120 | 263 |
| Mean Score: | 14.71 | 17.14 | 37.57 |

If subsequently it is learned that Person C was found to be an acquaintance of another person (Person D) for a period of years and Person D is known to have connections to radical sympathizers of a political movement, the connection with Person B is once again weighted accordingly. Note that there is still no connection to the missing explosives. Further, if it is then learned that a relative of Person A dies in a car crash having a great deal of cash and some chemicals similar to the missing explosives in his possession along with the phone number for Person C, the old datum is revived and is assigned a new weighted score in light of new information. The new weights may then be adjusted.

These subsequent developments, as represented by new data, reveal more than was originally discernable. This new data begins a whole new round of research. If not for the datum of information found many years before, no connection could have easily been made. That datum was still there and it was pivotal in forming the links.

The analyzer then makes assumptions from links and relationships, and information is cross-validated to gauge accuracy and credibility. Links and relationships are mapped in the data space to highlight clustering and identify current realities. The analytical process is continually tested to ensure accuracy.

The results from the analyzer are then sent to a display where trends can be demonstrated through the use of visualization tools which show alternative scenarios on the fly, linkages of various weights and intensities, and multi-dimensional representations. These various display representations are themselves used by the user of the system as an analytical tool as well as a vehicle for demonstration.

Consider the following as a hypothetical example. Assume that a study was commissioned to consider the terrorist activities in the US of a group called “Terrorist” based in the country “NottheUS”. For the example, assume that there are multiple spellings of “Terrorist” such as “Terrorest” and “Terroriste”. Then the acquisition of data would include using the search engines to search for “Terrorist”, “Terrorest”, and “Terroriste” among the public and proprietary websites.

Next the information is tagged and linked together and the links are weighted. Multiple references to the same source are removed to eliminate invalid corroboration. So in the example, assume “Bob Badguy” is the brother of “Steve Badguy” who is the information minister of “Terrorist”. Then “Bob Badguy” would be linked to “Steve Badguy” who is linked to “Terrorist”. If the relationship between Bob and Steve is only alleged and there are no documents to show an actual family relationship, then the weight of the link between Bob and Steve would be less than if birth certificates were produced showing that both individuals had the same mother.

Additional searching for “Bob Badguy” and “Steve Badguy” then finds that “Bob Badguy” was arrested in Texas for smuggling people from “NottheUS” into the US. As a result, there is a new link between “Terrorist” and the smuggling of people into Texas that was not known previously. Thus, the iterative use of searching, tagging, network generating and analysis provides additional information that that is used to modify the information previously gathered in each step.

It is important to consider that the method described above is applied to data by individual domain specialists. These individuals analyze the data within their own areas (domains) of expertise. Thus the weighting and connections between the data are established in part by these individual experts. Each such expert may establish links and weights not contemplated by other experts working on the same data set upon which each expert makes certain assumptions. By aggregating and integrating the weighted linked data set produced by one domain expert with that of other domain experts, weights may be collaboratively adjusted and links established that would not have otherwise been determined. Then a collaborative analysis takes place using the new assumptions that result from the aggregation. This process repeats itself throughout the analysis, with each collaborative iteration resulting in an expanded knowledge base. It is this aggregation and collaboration that increases the value and accuracy of the analysis using the linked weighted sets.

The foregoing description of the various embodiments of the invention is provided to enable any person skilled in the art to make and use the invention and its embodiments. Various modifications to these embodiments are possible, and the generic principles presented herein may be applied to other embodiments as well.

While the invention has been described in terms of certain exemplary preferred embodiments, it will be readily understood and appreciated by one of ordinary skill in the art that it is not so limited and that many additions, deletions and modifications to the preferred embodiments may be made within the scope of the invention as hereinafter claimed. Accordingly, the scope of the invention is limited only by the scope of the appended claims.

What is claimed is:

1. A method of organizing forecasting event data comprising the steps of:
for each of a plurality of users of the database:
acquiring a plurality of data;
tagging each datum with information about the datum;
creating weighted bi-directional relational links between data;
aggregating and integrating the tagged data and weighted bi-directional links from each of the plurality of users; and
collaboratively analyzing the plurality of data in response to the aggregated tagged data and weighted bi-directional links.

2. The method of claim 1 wherein the information about the data comprises:
source;
keywords;
context;
date and time;
probability of validity; and
weight.

3. The method of claim 1 wherein the information about the data comprises an indication of importance.

4. The method of claim 3 wherein the indication of importance is determined automatically.

5. The method of claim 1 further comprising the step of displaying paths through the weighted bi-directional relational links.

6. The method of claim 1 wherein the step of acquiring said plurality of data comprises the step of storing data from multiple sources.

7. The method of claim 1 wherein the steps of acquiring said plurality of data comprises the step of acquiring data in multiple formats and converting the data into a common format.

8. The method of claim 2 wherein the probability of validity of a datum is modified in response to other data.

9. The method of claim 1 further comprising the step of displaying the analysis.

10. The method of claim 9 wherein the display is multidimensional.

11. A system for organizing forecasting event data comprising:
a data acquisition module for acquiring a plurality of data;
a data tagger for tagging each data with information about the data; and
a network generator for creating weighted bi-directional relational links between data.

12. The system of claim 11 wherein the information about the data comprises:
source;
keywords;
context;
date and time;
probability of validity; and
weight.

13. The system of claim 11 wherein the information about the data comprises an indication of importance.

14. The system of claim 13 further comprising an importance determination module for automatically determining an indication of importance.

15. The system of claim 11 further comprising a display for displaying paths through the weighted bi-directional relational links.

16. The system of claim 11 further comprising a storage device for storing data from multiple sources.

17. The system of claim 11 wherein the data acquisition module acquires said plurality of data in multiple formats and converts said data into a common format.

18. The system of claim 12 further comprising a probability modification module for modifying the probability of validity of a datum in response to other data.

19. The system of claim 11 further comprising a display for displaying the analysis.
